(19) United States
(12) Patent Application Publication
(10) Pub. No.: US 2026/0356049 A1
(43) Pub. Date: Nov. 12, 2026

(54) SEALED POLYMER HOUSING INCLUDING TRANSPARENT WINDOW

(71) Applicant: Sensus Spectrum, LLC, Morrisville, NC (US)

(72) Inventors: Loren William James, New Hill, NC (US); Michael Zimmerman, Addison, PA (US)

(21) Appl. No.: 19/203,902

(22) Filed: May 9, 2025

(51) Int. Cl. B29C 65/20; B29K 23/00; B29L 31/26

(52) U.S. Cl. CPC B29C 65/20; B29K 2023/06; B29K 2023/38; B29L 2031/26

(57) ABSTRACT

Sealed housing structures formed from dissimilar polymeric materials are described. A housing includes a first material comprising high-density polyethylene and a second material comprising cyclic olefin copolymer, the second material forming a transparent window with defined optical and moisture barrier properties. A fused joint between the first material and the second material forms an integrated seal configured to limit vapor ingress. The housing defines an internal cavity adapted to enclose an electronic display within a moisture-controlled environment, enabling long-term visibility and protection using a fully polymeric construction.

### FIELD

The present disclosure generally relates to sealed enclosure systems, and more particularly, to polymer-based housing structures configured to enclose electronic components within a moisture-controlled internal environment while maintaining optical visibility of an internal electronic display.

### BACKGROUND

Electronic assemblies that include displays, sensors, or battery-powered modules are often enclosed within protective housings to mitigate exposure to environmental conditions such as moisture, particulate matter, and chemical contaminants. In some implementations, it is beneficial for the housing to provide a viewable interface, such as a transparent window, through which internal visual indicators may be observed.

Various enclosure architectures incorporate materials such as glass, metal, and elastomeric seals to form a physical barrier between internal assemblies and the surrounding environment. While these material systems are capable of achieving relatively low permeability and structural robustness, they may involve higher production complexity, elevated costs, or limitations related to wireless signal transmission and design flexibility.

Polymer-based enclosures are used in certain applications, for example due to their mechanical adaptability, cost efficiency, and radio frequency transparency. However, when a sealed housing incorporates polymers with dissimilar thermal or chemical properties, such as configurations requiring optical clarity and low moisture ingress, achieving a durable, continuous seal can present substantial technical challenges. Design considerations such as window thickness, surface preparation, and interfacial bonding can affect the sealing performance and long-term integrity of the housing.

Some enclosure systems attempt to compensate for moisture ingress through the use of desiccants, internal coatings, or secondary barriers, though these approaches may increase design complexity or reduce available internal volume. The interaction between material selection, wall thickness, and surface area can influence overall water vapor transmission performance in sealed assemblies used across a variety of operational environments.

### SUMMARY

Sealed housing structures formed from dissimilar polymeric materials are described. A housing includes a first material comprising high-density polyethylene and a second material comprising cyclic olefin copolymer, the second material forming a transparent window with defined optical and moisture barrier properties. A fused joint between the first material and the second material forms an integrated seal configured to limit vapor ingress. The housing defines an internal cavity adapted to enclose an electronic display within a moisture-controlled environment, enabling long-term visibility and protection using a fully polymeric construction.

Embodiments of the present disclosure can be described in view of the following clauses:
Clause 1. An enclosure configured to limit vapor ingress, comprising:
   an outer shell formed from high-density polyethylene (HDPE), the outer shell defining an opening;
   a transparent window formed from cyclic olefin copolymer (COC), the transparent window positioned to cover the opening; and
   a fused joint forming a continuous thermally bonded interface between the outer shell and the transparent window, the fused joint extending around the opening and characterized by a co-melted polymer interface with material continuity between the HDPE and COC components.
Clause 2. The enclosure of clause 1, wherein the fused joint is characterized by a co-melted region exhibiting material continuity between the HDPE of the outer shell and the COC of the transparent window at the continuous thermally bonded interface.

Clause 3. The enclosure of any of the preceding clauses, wherein the fused joint is formed by hot plate welding to produce a continuous polymer-to-polymer bond without adhesives or mechanical fasteners.
Clause 4. The enclosure of any of the preceding clauses, wherein the fused joint supports a burst pressure threshold of at least 150 psi.
Clause 5. The enclosure of any of the preceding clauses, wherein the fused joint exhibits a tensile strength that is at least 80 percent of a tensile strength of the outer shell.
Clause 6. The enclosure of any of the preceding clauses, wherein the enclosure exhibits a water vapor transmission rate of less than 0.0003 grams per package per day.
Clause 7. The enclosure of any of the preceding clauses, wherein the fused joint extends along a region surrounding the opening and is dimensioned to limit moisture ingress at the bonded interface.
Clause 8. The enclosure of any of the preceding clauses, wherein the transparent window comprises a COC material having an optical transmittance of at least 50% in the visible light spectrum.
Clause 9. The enclosure of any of the preceding clauses, wherein the transparent window includes a nominal thickness of at least 2 millimeters.
Clause 10. The enclosure of any of the preceding clauses, wherein the transparent window is formed as a planar, lens-shaped, or contoured insert configured to optically align with internal electronics.
Clause 11. The enclosure of any of the preceding clauses, wherein the outer shell includes high-density polyethylene (HDPE) selected from Black TOSAF HDPE KE900249, DOW® HDPE 8907 NT7, or a blend comprising between 85% and 95% HDPE and between 5% and 15% TOPAS® COC 8007S-04 by weight.
Clause 12. A welded assembly comprising:
   a first portion formed from high-density polyethylene;
   a second portion formed from cyclic olefin copolymer; and
   a fused joint joining the first portion and the second portion, the fused joint comprising a continuous thermally bonded interface defined by a co-melted region exhibiting material continuity between the high-density polyethylene of the first portion and the cyclic olefin copolymer of the second portion.
Clause 13. A method of forming a fused polymeric joint, the method comprising:
   providing a first material comprising HDPE, the first material defining a housing and including an opening extending through a portion of the housing, the opening including a first bonding surface proximate a perimeter of the opening;
   providing a second material comprising COC, the second material comprising an optically transmissive material configured to exhibit an optical transmittance of at least 30 percent within the visible light spectrum, the second material including a second bonding surface proximate a perimeter of the second material and configured to correspond to the first bonding surface;
   positioning the first material and the second material in opposing fixtures of a hot plate welding system;
   heating the first bonding surface to a first temperature;
   heating the second bonding surface to a second temperature;
   compressing the first bonding surface and the second bonding surface together under an applied force for a first duration to form a fused joint between the first material and the second material, the fused joint being configured to provide a continuous, unified bond between the first material and the second material.
Clause 14. The method of clause 13, wherein the first bonding surface and the second bonding surface are heated concurrently using a dual-sided platen of the hot plate welding system.
Clause 15. The method of clause 13, wherein the first temperature is within a range of 420 °F to 500 °F and the second temperature is within a range of 420 °F to 500 °F.
Clause 16. The method of clause 13, wherein compressing the first bonding surface and the second bonding surface comprises applying a compressive force in a range between 500 pounds and 1,000 pounds for a seal duration of between 15 seconds to 20 seconds.
Clause 17. The method of clause 13, wherein the fused joint extends continuously along the perimeter of the opening and is configured to withstand internal burst pressures of at least 150 psi.
Clause 18. The method of clause 13, wherein the fused joint exhibits a tensile strength of at least 80 percent of a tensile strength of the first material.
Clause 19. The method of clause 13, wherein the second material exhibits an optical transmittance of at least 50 percent in a visible light spectrum between 400 nanometers and 700 nanometers.
Clause 20. The method of clause 13, wherein the housing formed by the first and second materials exhibits a package-level water vapor transmission rate not exceeding 0.0003 grams per package per day.

### BRIEF DESCRIPTION OF THE DRAWINGS

Throughout the drawings, reference numbers can be re-used to indicate correspondence between referenced elements. The drawings are provided to illustrate embodiments of the present disclosure and do not limit the scope thereof.

FIG. 1 illustrates a perspective view of an example enclosure system configured to enclose an electronic display within a housing.

FIG. 2 illustrates a cross-sectional view of a portion of the enclosure system of FIG. 1, showing a fused joint formed between dissimilar polymeric components and internal electronic modules positioned within a sealed cavity.

FIG. 3 illustrates an oblique perspective view of the enclosure system of FIG. 1, showing an assembled housing structure with external mounting interfaces and a viewable electronic display.

FIG. 4 illustrates a schematic process diagram representing an example welding procedure for forming the sealed joint between dissimilar polymeric components.

### DETAILED DESCRIPTION

Enclosure systems for electronic assemblies often operate in environments where long-term exposure to moisture, temperature fluctuations, and physical stress can degrade internal components. In some cases, these assemblies include electronic displays, such as LCDs, that must remain visible while protected from environmental conditions. Applications such as remote metering, outdoor monitoring, and infrastructure instrumentation can benefit from sealed housings that offer both optical accessibility and low permeability to water vapor and other gases.

Traditional enclosure designs frequently utilize combinations of metal, glass, and elastomeric materials to form sealed housings. These configurations can provide a degree of hermeticity and mechanical protection, but they often introduce tradeoffs related to cost, manufacturability, and design flexibility. In some scenarios, the inclusion of gaskets or adhesives to bond dissimilar materials may increase production complexity or reduce long-term sealing performance. Moreover, rigid metal-glass constructions may limit compatibility with wireless communication systems due to reduced RF transparency.

All-polymer housings have been explored in certain domains for their lightweight construction, RF-transparency, and moldability. However, achieving both optical clarity and long-term environmental sealing using entirely polymeric materials has presented technical challenges. In particular, bonding dissimilar polymers (e.g., a transparent polymer and a structural polymer) into a continuous, sealed interface capable of low water vapor transmission has proven difficult. Variations in surface energy, melt behavior, and mechanical properties among polymer classes often inhibit direct fusion and compromise seal integrity.

Some inventive concepts described herein relate to polymer-based enclosures configured to house electronic displays in sealed internal cavities. The enclosure can be formed from dissimilar polymers selected to provide specific combinations of structural support, environmental resistance, and optical transmittance. In some cases, the enclosure includes a second material (sometimes referred to as a transparent window region) through which a non-backlit display, such as an LCD can be viewed during operation. The structural materials can be selected based at least in part on their barrier properties, mechanical compatibility, and suitability for forming a continuous, moisture-limiting seal.

Some inventive concepts described herein relate to sealed housing structures that incorporate dissimilar polymeric components joined to form a moisture-limiting enclosure. In some cases, the housing includes a first material forming at least part of an outer enclosure and a second material forming a transparent window through which an internal display may be viewed. The first material can include a structural-grade polymer, including neat or blended formulations such as high-density polyethylene (HDPE), polypropylene (PP), or polyethylene terephthalate (PET). In some cases, the first material may include a blend of HDPE and cyclic olefin copolymer (COC), for example to improve thermal bonding compatibility with the transparent window. The second material can include a moisture-barrier, optically transmissive polymer, including materials such as COC, polycarbonate (PC), or polyethylene naphthalate (PEN).

Some inventive concepts described herein relate to the use of a fused joint between the first material and the transparent window to form a sealed interface without adhesives or mechanical fasteners. In some implementations, the joint is formed by hot plate welding. In some cases, the joint is formed by thermal conduction welding, laser welding, or other heat-based bonding techniques. In other cases, the joint can be formed using pressure-assisted fusion, localized heating with controlled cooling, or alternative bonding methods selected based at least in part on the material pairing and fabrication environment. The fused joint can support mechanical integrity and environmental sealing performance across a range of structural geometries and deployment conditions.

Some inventive concepts described herein relate to housing configurations in which the internal cavity is adapted to enclose an electronic display within a controlled environment. The transparent window can exhibit defined optical transmittance and water vapor barrier characteristics such that the overall enclosure achieves a low water vapor transmission rate (WVTR) over multi-year timeframes. In some cases, the thickness and material properties of the enclosure components are selected to support extended product lifespans, including deployments in outdoor or submerged conditions.

Some inventive concepts described herein relate to a sealed housing that can include a fully polymeric construction with a transparent window and a fused joint configured to establish a moisture-controlled internal environment. The housing can be configured to enclose an electronic display in a manner that supports long-term optical visibility and environmental isolation. In some implementations, the enclosure can exhibit a water vapor transmission rate selected to maintain display functionality over extended service lifetimes. The disclosed structure can integrate optical, structural, and sealing functions using polymeric materials joined through a continuous fused interface, supporting applications that involve exposure to moisture, submersion, or outdoor deployment conditions.

Some inventive concepts described herein relate to structural enclosures that can be formed entirely from polymeric materials. The enclosure can include dissimilar polymers joined through a continuous fused interface that can provide environmental sealing performance without the use of adhesives, gaskets, or rigid multi-material assemblies. The fused joint between the first material and the transparent window can be configured to limit moisture ingress while supporting mechanical strength, dimensional stability, and compatibility with RF-transparent operation.

Some inventive concepts described herein relate to enclosure architectures that can satisfy both functional performance targets and manufacturing requirements. The housing structure can be formed using molding and welding techniques suitable for high-volume production environments. The resulting assembly can include a transparent window integrated into a housing 120 using a fused joint, and can be configured to provide low water vapor transmission, optical access to internal components, and mechanical durability over extended deployment intervals. The disclosed configuration can be adapted for use in sealed housings for electronic displays operating in embedded, outdoor, or moisture-exposed environments.

Some inventive concepts described herein relate to a method for forming a sealed polymeric housing configured to enclose electronic components within a moisture-controlled environment. In some implementations, the method includes positioning a first material and a transparent window into opposing tool fixtures of a hot plate welding system. The first material can include a structural polymer, and the transparent window can include a moisture-barrier, optically transmissive polymer. In some cases, both components are concurrently heated using a dual-sided platen at defined surface temperatures, such that respective bonding surfaces reach a melt state. Following the heating cycle, the components can be compressed together under pressure for a defined seal duration to form a fused joint between the dissimilar polymers. In some implementations, the process parameters (e.g., heating time, contact force, seal pressure, and thermal profile) can be selected based at least in part on material-specific characteristics and the desired strength or vapor transmission properties of the resulting housing. The welded joint can provide mechanical bonding and environmental sealing without requiring adhesives, gaskets, or supplemental barrier liners.

Some advantages associated with the inventive concepts described herein can include enhanced environmental sealing performance, simplified material integration, and support for scalable fabrication techniques. The use of polymeric materials, such as high-density polyethylene and cyclic olefin copolymer, can facilitate construction of a sealed housing that provides both moisture control and optical visibility for internal display components. In some cases, the housing can be formed without adhesives, gaskets, or rigid glass-to-metal seals, which may support reduced assembly complexity and material diversity. The polymeric construction can be compatible with RF-transparent applications and may offer structural resilience suitable for deployment in various environmental conditions. Additionally, a fused joint between dissimilar polymers can be formed using thermal bonding techniques, which may support repeatable manufacturing processes while establishing a continuous seal configured to limit vapor ingress. These and other advantages can be realized in enclosure systems deployed across a range of product environments, including metering, monitoring, and embedded electronic platforms.

### Example Enclosure System

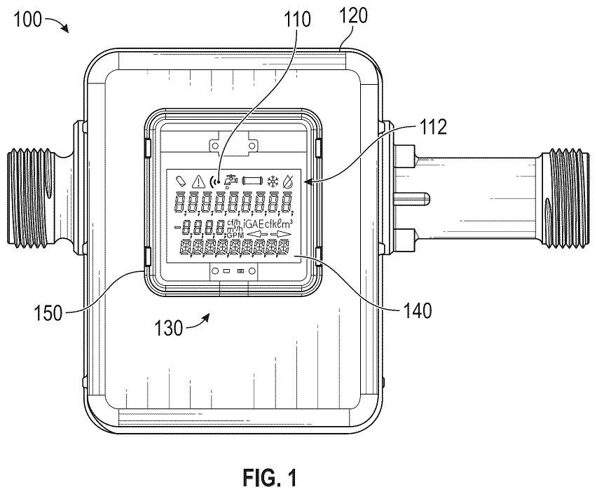

FIG. 1 illustrates a perspective view of an example enclosure system 100 configured to enclose an electronic display 110 within a housing 120. The enclosure system 100 can be implemented in utility metering platforms, remote sensing devices, or embedded electronics deployed in moisture-prone or outdoor environments. The enclosure system 100 includes the housing 120 and can include one or more internal components positioned within an internal cavity defined by the housing 120. The housing 120 can form a sealed barrier against vapor ingress and can include a transparent window 112 to allow optical access to one or more internal components, such as the electronic display 110. In some implementations, a potting or fill material 150 can be included within the internal cavity to facilitate mechanical support, encapsulation, or environmental isolation for internal electronics.

The enclosure system 100 includes an outer shell 130 (sometimes referred to as a first material) and a transparent window 112 (sometimes referred to as a second material 140). The outer shell 130 can form a primary body portion of the housing 120 and can provide structural rigidity, impact resistance, and/or mounting support. In some implementations, the outer shell 130 can include a structural-grade polymer, including, but not limited to, HDPE, polypropylene (PP), polyethylene terephthalate (PET), or polyethylene naphthalate (PEN). In some cases, the outer shell 130 can be formed from a polymer blend that includes HDPE and COC, with the COC present in a range from 1% to 30%, from 3% to 15%, or from 5%-10% by weight. Non-limiting examples of compositions of the outer shell 130 include blends of 5% or 10% TOPAS COC 8007S-04 with 95% or 90% Black TOSAF HDPE (KE900249), respectively. In some such cases, the Black TOSAF HDPE (KE900249) can include a masterbatch based on DOW HDPE 8907 NT 7 with one or more additives such as, but not limited to, ultraviolet stabilizers, thermal stabilizers, antioxidants, or carbon black. Other non-limiting examples of compositions of the outer shell 130 can include HDPE blended with maleic anhydride-grafted polyethylene (HDPE-g-MA), HDPE blended with ethylene vinyl alcohol (EVOH), HDPE blended with polyethylene-co-vinyl acetate (EVA), HDPE blended with linear low-density polyethylene (LLDPE), HDPE/medium-density polyethylene (M DPE) reactor-grade copolymers, or HDPE blended with barrier masterbatches such as nanoclay or silica-based additives. The material selection for the outer shell 130 can be based at least in part on its barrier properties, weld compatibility, dimensional stability, or performance in thermally bonded assemblies. In some cases, the outer shell 130 can include molded features such as flanges, mounting collars, sealing grooves, or receiver structures for integration with external systems or housings.

The second material 140 can define at least a portion of the transparent window 112 of the housing 120 and can be joined, via a fused joint (not shown), to the outer shell 130 to form a sealed cavity. The second material 140 can include an optically transmissive and/or moisture-barrier polymer material, such as, but not limited to, COC, polycarbonate (PC), polyethylene terephthalate (PET), or modified acrylic blends. In some implementations, the transparent window 112 can be positioned along a viewing-facing region of the housing 120 and aligned to permit optical access to internal components positioned within the sealed cavity. The transparent window 112 can be formed as a planar insert, a shaped lens, or an integrated molded section, and can exhibit sufficient optical clarity and moisture barrier performance to support long-term deployment of sealed electronic assemblies in environments subject to humidity, condensation, or submersion.

In some implementations, the transparent window 112 can include an optically transmissive material configured to exhibit an optical transmittance of at least 30% in the visible light spectrum (e.g., 400-700 nanometers). In some cases, the optical transmittance of the transparent window 112 can be at least 40%, 50%, 60%, 70%, 80%, or 90% (+/−5%). The transparent window 112 can include a nominal wall thickness of at least 1 millimeter, and in some implementations, at least 2 mm, 3 mm, or 4 mm (+/−5mm). In some cases, a transparent region of the transparent window 112 can define a viewing area of at least 15 cm², at least 25 cm², or at least 40 cm². In some implementations, one or more physical or optical properties of the transparent window 112 can vary across its surface area. For example, the transparent window 112 can include tapered wall sections, locally thickened regions, compound curvature, or non-uniform transmittance zones resulting from material distribution, localized surface treatments, or integrated optical features.

In some cases, the transparent window 112 can be positioned on a major face of the housing 120, such that the viewing axis is substantially perpendicular to a display surface or viewing angle.

In some implementations, the enclosure system 100 can be configured to exhibit a WVTR below defined package-level thresholds, expressed in grams per package per day. The package-level WVTR can represent cumulative moisture ingress across the housing 120, including the outer shell 130, the transparent window 112, and the fused joint. Example WVTR thresholds can include values less than 0.0006, 0.0005, 0.0004, 0.0003, 0.0002, or 0.0001 grams per package per day. In some cases, the WVTR may fall within a tolerance of ±10% of a defined target value. The WVTR can be measured based on steady-state diffusion across the housing 120 under controlled humidity and temperature conditions. In some implementations, the WVTR of the housing 120 can reflect the combined moisture barrier characteristics of multiple regions and materials. For example, the outer shell 130 and the transparent window 112 can exhibit different intrinsic permeabilities to water vapor, contributing differently to the overall package-level WVTR. In some cases, joint regions, wall transitions, or interface geometries can contribute to non-uniform diffusion paths that influence cumulative vapor ingress over time. In some cases, the WVTR is measured as a cumulative property of the housing 120, representing the total rate of moisture ingress across all enclosure surfaces and interfaces. Localized variations in material composition, wall thickness, or structural geometry can influence the overall package-level WVTR by altering the diffusion characteristics of individual regions within the housing 120. In some cases, a WVTR of less than 0.0003 g/package/day can support a service interval of 5, 10, 20, or more years in ambient outdoor conditions. In some cases, the housing 120 can be configured to achieve any of the foregoing WVTR thresholds based on material properties and joint configuration, without requiring internal desiccants, coatings, or barrier liners, although such features may be additionally included.

In some implementations, the transparent window 112 can exhibit a WVTR defined on a per-area basis, such as less than 0.03, 0.01, or 0.005 grams per square meter per day. The WVTR characteristics of the transparent window 112 can vary based on polymer formulation, wall thickness, and orientation within the housing 120. In some cases, a wall thickness of approximately 3 millimeters to 4 millimeters in the transparent window 112 can support package-level WVTR values at or below 0.0002 grams per package per day for the housing 120. In other cases, the transparent window 112 can be formed with a thinner profile (e.g., 1 mm to 2 mm) when higher WVTR tolerances are acceptable, including thresholds such as 0.001 or 0.005 grams per package per day.

The electronic display 110 can include a reflective LCD bistable indicator, or other passive display module configured to present metering data, status indicators, or sensor outputs. The electronic display 110 can be mounted to an internal circuit board or structural frame and can be positioned to align with the transparent region defined by the transparent window 112. In some implementations, the electronic display 110 can operate without backlighting, such that visibility is maintained under ambient lighting conditions through the optically transmissive window. In other implementations, the electronic display 110 can be backlit or selectively illuminated depending on the power configuration or viewing requirements of the application. The housing 120 can support display readability under a variety of environmental conditions, including indoor, outdoor, and submersible deployments. In some cases, one or more additional or alternative internal components, such as power sources, sensor modules, processing elements, or communication interfaces, can be positioned within the internal cavity of the housing 120.

In some cases, the enclosure system 100 can include external coupling or interface features, such as threaded collars, snap-fit edges, or mounting brackets, configured to engage with a meter body or fixture assembly. In some cases, antenna assemblies or communication components can be integrated within or mounted to the housing 120 using sealed feedthroughs or RF-transparent sections. The housing 120 can include molded-in features such as alignment tabs, gasket channels, or structural ribs configured to facilitate assembly while preserving sealing integrity.

In some cases, the housing 120 defines a generally rectangular or prismatic structure. In some cases, the housing 120 defines another geometries. In some cases, the enclosure system 100 may have external dimensions of less than 150 mm in length, less than 100 mm in width, and less than 70 mm in height. In some cases, the total internal volume can be less than 1, 2, 3, 4, or 5 liters, or in some cases less than 500 cubic centimeters. Structural walls of the housing 120 can be formed with uniform or tapered thicknesses, including, but not limited to, variations between 1 mm and 5 mm.

In some cases, the potting or fill material 150 can be introduced into the internal cavity after assembly of the enclosure system 100. The potting material 150 can be used to encapsulate one or more internal components, including the electronic display 110, circuit boards, or conductive traces, or can serve to mechanically stabilize these components within the housing 120. In some implementations, the potting material 150 can include a polymeric or elastomeric formulation such as a silicone, epoxy, or polyurethane resin. In some cases, the potting material 150 can exhibit moisture-curing, thermal-curing, or UV-curing properties selected to match assembly conditions. The potting material 150 can be selected based at least in part on its dielectric strength, thermal expansion coefficient, or compatibility with internal component surfaces. In some cases, the fill can extend across all or part of the internal cavity volume, forming a continuous encapsulant or a localized protective layer. In some cases, the potting or fill material 150 can be applied to a defined depth or targeted region to support airflow, serviceability, or modular repair access. In some implementations, the potting or fill material 150 can improve the enclosure's resistance to vibration, impact shock, or environmental ingress at component interfaces.

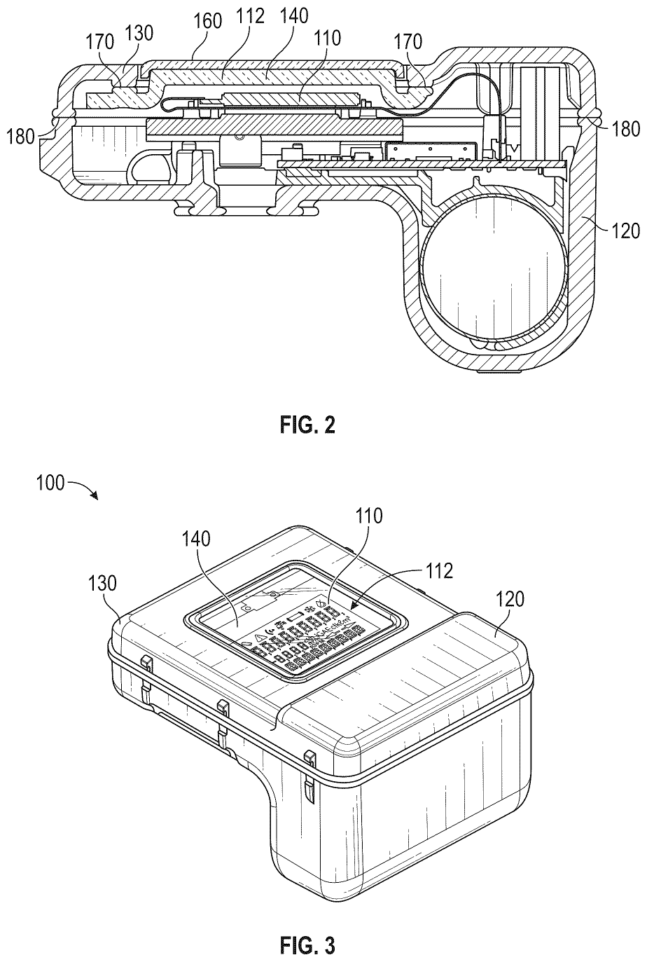

FIG. 2 illustrates a cross-sectional view of a portion of the enclosure system 100 of FIG. 1, showing internal electronic components positioned within a sealed cavity defined by the housing 120. The cross-section illustrates a fused joint 170 formed between the outer shell 130 and the transparent window 112, with the electronic display 110 aligned beneath the transparent window 112 formed by the second material 140. A UV film or protective layer 160 is positioned on an exterior-facing surface of the transparent window 112 and can be configured to provide ultraviolet light attenuation, scratch resistance, or surface protection. The enclosure system 100 can include a second fused joint 180 formed between adjacent outer shell portions 130 of the housing 120. This joint (e.g., a HDPE-to-HDPE) can contribute to structural continuity and environmental sealing across the housing 120.

The fused joint 170 can be formed as a continuous thermally bonded interface between the outer shell 130 and the transparent window 112. In some implementations, the fused joint 170 can be formed using hot plate welding, in which mating surfaces of the polymer components are heated via a dual-sided platen until softened, then compressed under pressure to form a unitary bonded interface. In some cases, the fused joint 170 can be formed using alternative joining methods such as laser welding, infrared bonding, or pressure-assisted melt fusion. The joint interface can be dimensioned and positioned to limit moisture ingress and mechanical failure under thermal cycling or mechanical shock.

In some implementations, the fused joint 170 can include a weld bead, interlocking melt flow, or contour-matched joint geometry selected based at least in part on the rheological behavior of the outer shell 130 and the transparent window 112. In some cases, the fused joint 170 can span a continuous perimeter around a window region or cavity opening and can be positioned along a stepped flange or undercut ledge to increase bonding surface area and mechanical interlock.

The internal cavity of the housing 120 can house one or more electronic modules, such as printed circuit boards (PCBs), power supplies, sensor packages, or control electronics. As shown in FIG. 2, the electronic display 110 can be mounted in alignment with the transparent window 112, positioned to be optically visible through the transparent window 112. Additional internal components 182 may include a battery compartment, antenna feedthroughs, memory modules, or environmental sensors configured to operate within the sealed cavity.

In some implementations, the housing 120 can include integrated mounting features, cable routing channels, or alignment structures molded into the outer shell 130. These features can be used to secure internal modules and to maintain spacing, strain relief, or thermal isolation between components. In some cases, the cavity geometry can include ribs, guides, or standoffs configured to locate and retain electronics during assembly.

The internal arrangement shown in FIG. 2 can support airflow restriction, vapor diffusion control, and condensation management within the sealed cavity. In some cases, surface coatings, vapor barriers, or integrated vapor sinks can optionally be included to further manage internal humidity, although the housing 120 can be configured to meet defined vapor ingress thresholds without such supplemental features. The positioning and contouring of the fused joint 170 can reduce stagnation regions or moisture pooling near sensitive electronics.

In some implementations, the UV film or protective layer 160 can include a discrete sheet, laminate, or coating applied to at least a portion of an exterior-facing surface of the transparent window 112. The UV film or protective layer 160 can be formed from a polymeric substrate such as polycarbonate, acrylic, polyethylene terephthalate (PET), or fluoropolymer, and can include additives or treatments configured to absorb or reflect ultraviolet radiation. In some cases, the UV film or protective layer 160 is configured to block at least 90%, 95%, or 99% of incident UV light within the 280-400 nanometer range. In some implementations, the UV film or protective layer 160 can include anti-reflective, anti-scratch, or hydrophobic coatings to support optical performance and durability during outdoor or industrial use. The UV film or protective layer 160 can be bonded, laminated, or mechanically retained on the surface of the transparent window 112, and may be selected to maintain visible light transmittance within defined thresholds while reducing yellowing, hazing, or material degradation over time.

The second fused joint 180 can be formed between adjacent segments of the outer shell 130, such as between a base portion and a cover portion of the housing 120. In some implementations, the second fused joint 180 is formed by hot plate welding two regions of the outer shell 130 to produce a continuous, thermally bonded interface. The joint can extend along a perimeter seam, edge flange, or stepped wall section of the housing 120. In some cases, the second fused joint 180 is configured to provide mechanical strength, dimensional alignment, and moisture sealing performance comparable to a monolithic structure. The joint geometry can include a planar weld surface, a recessed bonding groove, or an interlocking contour configured to promote melt flow and interfacial adhesion during the welding cycle. In some implementations, the second fused joint 180 is formed concurrently with or separately from the fused joint 170 between the outer shell 130 and the transparent window 112. The use of hot plate welding for both fused joints 170 and 180 can support consistent fabrication using compatible thermal profiles and tooling configurations. In some implementations, the second fused joint 180 is a thermally bonded interface formed by welding two HDPE surfaces to produce a continuous polymer-to-polymer connection.

FIG. 3 illustrates an oblique perspective view of the enclosure system 100 of FIG. 1, showing an assembled housing structure with external mounting interfaces and the electronic display 110. The illustration shows example exterior contours of the housing 120, including the transparent window 112 formed by the second material 140. In some implementations, the housing 120 includes an integrated port or coupling interface for mechanical attachment to a pipe, conduit, or fixture body. The view also shows assembled alignment between the outer shell 130 and the transparent window 112 following formation of the fused joint.

### Example Polymer Bonding and Joint Formation Using Hot Plate Welding

Polymeric enclosures can include openings that are configured to receive transparent inserts, such as windows aligned with electronic displays or visual indicators. In some cases, the enclosure can be formed from a structural polymer such as high-density polyethylene, and the transparent insert can include a barrier polymer such as cyclic olefin copolymer. These materials can exhibit distinct thermal and mechanical characteristics, which can present challenges during manufacturing, particularly in applications that require a continuous seal between dissimilar materials.

To address these or other challenges, a thermal bonding process can be used to join an HDPE material and the transparent insert without adhesives or fasteners. In some implementations, a hot plate welding procedure can be applied to heat respective bonding surfaces of the HDPE material and the transparent insert to weldable conditions. The components can be joined at a perimeter region surrounding the window opening and compressed to form a fused joint. The resulting joint can provide a unified material connection that supports structural integrity, optical alignment, and environmental sealing.

The disclosed process can be compatible with polymeric materials that differ in melt behavior and surface properties, and can be adapted to support a range of housing geometries and optical window configurations. The joined structure can be used in sealed housings, environmental monitoring devices, or other assemblies where transparent access and long-term durability are desired.

In some implementations, the thermal bonding process can be applied to specific material combinations involving HDPE and COC. For example, the first component can include Black TOSAF HDPE (KE900249), and the second component can include TOPAS COC 8007S-04. In some implementations, the first component can include natural (unpigmented) DOW HDPE 8907 NT 7. The welding process can be configured to join either Black TOSAF HDPE (KE900249) or DOW HDPE 8907 NT7 to TOPAS COC 8007S-04 using hot plate welding at defined temperatures, contact pressures, and dwell durations as described herein.

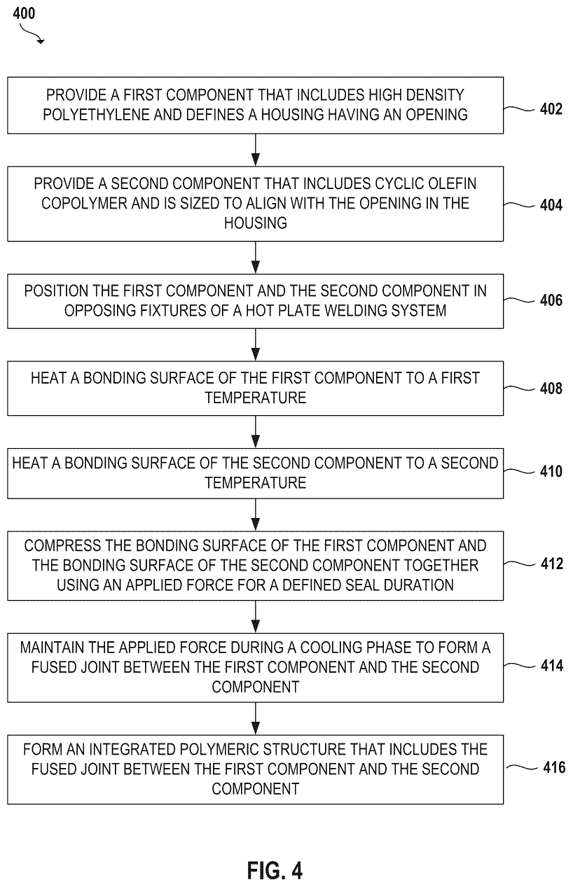

FIG. 4 presents a flow diagram illustrating an embodiment of a routine 400 for forming a fused joint between dissimilar polymeric materials. The routine 400 can be used to fabricate a sealed structure in which a transparent polymer insert is welded into a structural housing. In some cases, the routine 400 can be implemented using a hot plate welding system configured to support material-specific heating and pressure-based joining. While described in the context of a housing and window structure, the routine 400 can be adapted to other applications involving HDPE and COC components joined along a planar or contoured interface.

At block 402, a first component that includes high density polyethylene and defines a housing having an opening can be provided. In some cases, the first component can be a molded wall section, panel, or partial housing configured to support later integration into a complete enclosure. The opening can be formed through a wall portion of the first component and can define a region associated with a viewing area, optical interface, or display window. The opening can be circular, rectangular, or have another defined shape, and can include a bonding surface along a perimeter region of the wall. In some cases, the first component includes a thickness between 2 millimeters and 6 millimeters. In some cases, the first component can be configured to receive additional HDPE components through prior, concurrent, or subsequent welding or assembly operations.

At block 404, a second component that includes cyclic olefin copolymer and is sized to align with the opening in the housing can be provided. In some cases, the second component can be a transparent window, lens, cover panel, or optical insert. The second component can include a bonding surface located proximate a perimeter region and can be configured to overlap the opening defined in the first component. The second component can be positioned on an interior-facing surface or an exterior-facing surface of the first component. In some implementations, the second component includes a thickness between 2 millimeters and 4 millimeters. In some implementations, the second component includes a thickness greater than 4 millimeters or less than 2 millimeters. In some cases, the second component includes a UV-protective coating or a surface-adhered optical film. In some cases, the second component includes an integrated UV-absorbing layer formed as part of the bulk material. The bonding surface of the second component can define a planar contact region, a contoured edge, or a stepped geometry configured to interface with the first component during thermal bonding.

At block 406, the first component and the second component can be positioned in opposing fixtures of a hot plate welding system. In some cases, the welding system includes a dual-sided platen configured to simultaneously heat opposing surfaces of the components. In some cases, the welding system includes a single-sided platen that is repositioned or indexed between heating cycles. The system can include mechanical clamping fixtures configured to retain the components during the heating, compression, and cooling phases. In some cases, the fixtures include pneumatically actuated clamps, spring-loaded contact plates, or threaded retainers. The components can be oriented such that the bonding surfaces face one another in parallel alignment. In some implementations, the bonding surfaces are aligned in a horizontal plane; in some implementations, the bonding surfaces are vertically or angularly oriented depending on the system configuration. The fixtures can include alignment features such as mechanical guide rails, stop pins, keyed recesses, or conformal nests that match the geometry of the components. In some cases, the fixturing system includes sensors or feedback elements to verify component position prior to welding. In some cases, component positioning is performed manually with visual alignment indicators or mechanical stops.

At block 408, a bonding surface of the first component can be heated to a first temperature. The bonding surface can be positioned proximate a perimeter region of the opening defined in the first component. The heating process can be configured to soften the HDPE material to a weldable state while maintaining geometric integrity. In some cases, the bonding surface is heated using a hot plate welding process in which the surface is brought into contact with a heated platen for a defined thermal dwell period.

In some cases, the first temperature is between 420 degrees Fahrenheit and 500 degrees Fahrenheit. Additional example temperatures can include 430 degrees, 440 degrees, 460 degrees, or 480 degrees Fahrenheit. In some cases, the first temperature falls within a tolerance of ±10 percent of a defined target value. In some cases, the bonding surface is heated for a duration between 6 seconds and 10 seconds. Other example durations can include 7 seconds, 8 seconds, or 9 seconds, and may similarly fall within a tolerance of ±10 percent of a selected nominal value.

Heating can be performed using a contact-based platen configured to conduct thermal energy directly to the bonding surface. In some implementations, heating can be performed using an electrically heated surface, a cartridge-heated plate, or an embedded resistance element. In other implementations, the bonding surface can be heated using non-contact thermal sources, such as focused infrared energy, radiant heat, or convective airflow. In some cases, localized preheating or multi-zone heating control can be applied to specific subregions of the bonding surface to account for variable thicknesses or complex geometries. The heating profile can be selected to achieve surface softening without excessive thermal degradation or warping of the HDPE structure.

At block 410, a bonding surface of the second component can be heated to a second temperature. The bonding surface can be located proximate a perimeter region of the second component, such as an edge portion configured to overlap the opening defined in the first component. In some cases, the bonding surface is heated using a hot plate welding process in which the surface is brought into contact with a heated platen for a defined thermal dwell period. In some implementations, the bonding surface of the second component is heated concurrently with the bonding surface of the first component using a dual-sided platen. In some implementations, the second component is heated before or after the first component using a sequential heating procedure.

The second temperature can be selected to soften the cyclic olefin copolymer material while maintaining structural and optical properties. In some cases, the second temperature is between 420 degrees Fahrenheit and 500 degrees Fahrenheit. Additional example temperatures can include 430 degrees, 445 degrees, 470 degrees, or 485 degrees Fahrenheit. In some cases, the second temperature is equal to the first temperature. In some cases, the second temperature differs from the first temperature based at least in part on the thermal properties of the respective materials. In some cases, the second temperature falls within a tolerance of ±10 percent of a defined target value.

The bonding surface can be heated for a duration between 6 seconds and 10 seconds. Some example durations can include 7 seconds, 8 seconds, or 9 seconds, and may fall within a tolerance of ±10 percent of a selected nominal value. Heating can be performed using a contact-based platen, an embedded resistance heater, or a thermally controlled fixture surface. In some implementations, heating can be performed using radiant energy, infrared heating, or convective flow directed at the bonding region. In some cases, the second component is supported in a fixture configured to limit deflection or optical distortion during heating. The heating conditions can be selected to promote bonding readiness without inducing discoloration, bubbling, or surface hazing in the COC material.

At block 412, the bonding surface of the first component and the bonding surface of the second component can be compressed together using an applied force for a defined seal duration. In some cases, the applied force is delivered by a mechanical actuator, a pneumatic ram, or a servo-controlled platen drive. In some implementations, compression is performed along a vertical axis between two opposing fixtures. In some cases, compression is performed in a horizontal or angled orientation based on the welding system configuration.

In some cases, the applied force is between 500 pounds and 1,000 pounds. Some example force values can include 600 pounds, 750 pounds, or 900 pounds, and can fall within a tolerance of +10 percent of a defined target value. In some cases, a lower force value such as 400 pounds can be used in configurations with reduced bonding surface area or thinner wall sections. The seal duration can be selected to maintain bonding conditions for sufficient interfacial fusion. In some cases, the seal duration is between 10 seconds and 20 seconds. Some example durations can include 12 seconds, 15 seconds, or 18 seconds, with similar +10 percent tolerances applied.

Compression can promote polymer flow, interfacial wetting, and molecular interdiffusion between the softened bonding surfaces. In some cases, a flash flow bead or melt ring can be formed at the edge of the bonded region as a result of displaced material during compression. In some cases, the joint geometry is configured to capture or contain flow within a recessed channel or flange to prevent external flash. The magnitude of applied force and the rate of compression can be configured to balance joint strength, alignment tolerance, and visual appearance. In some cases, the compression step is initiated immediately after the heating cycle; in some cases, a brief delay is included to stabilize the bonding surfaces before contact.

At block 414, the applied force can be maintained during a cooling phase to form a fused joint between the first component and the second component. In some cases, the cooling phase begins immediately following the compression step and is carried out while the components remain held in fixed alignment. The applied force can be maintained throughout the cooling phase to preserve joint geometry, prevent displacement, and ensure consistent interfacial contact.

In some cases, cooling occurs under ambient thermal conditions with passive heat dissipation through the fixture surfaces or surrounding air. In some cases, active cooling is applied using airflow, chilled air jets, liquid-cooled backing plates, or integrated thermal sinks incorporated into the welding system. In some implementations, the fixture includes metal inserts or thermally conductive plates to accelerate heat transfer from the bonded region.

The duration of the cooling phase can vary based on the thermal mass of the components, the thickness of the bonded region, and the target mechanical properties of the joint. In some cases, the cooling phase lasts between 5 seconds and 30 seconds. Some example durations can include 10 seconds, 20 seconds, or 25 seconds, and may fall within a tolerance of ±10 percent of a selected nominal value. In some cases, the force applied during the compression step is held constant throughout the cooling phase. In some cases, the force is gradually reduced according to a defined ramp-down profile to relieve residual stress or control joint contour.

The cooling phase can result in the formation of a continuous, fused interface at the bond line, sometimes referred to herein as a continuous fused joint. In some cases, the fused joint defines a generally uniform weld bead or flattened interface free of voids or delamination. The joined structure can retain its dimensional configuration during cooling and be prepared for subsequent processing, handling, or integration into an assembly.

At block 416, an integrated polymeric structure that includes the fused joint between the first component and the second component can be formed. The fused joint can result from the cooling and solidification of thermally softened regions previously subjected to compression. In some cases, the fused joint defines a continuous material interface that extends around the full perimeter of the opening formed in the first component. In some cases, the joint spans a partial perimeter or defines a geometric path such as a frame, collar, or enclosed flange region.

The integrated polymeric structure can include a sealed enclosure, panel assembly, or multi-part housing formed entirely from thermoplastic materials. In some implementations, the structure includes a transparent window (e.g., the second component) bonded to a wall segment of a housing. In some cases, the joined structure is a subassembly that is subsequently incorporated into a larger enclosure using additional thermal bonding, snap-fit coupling, or mechanical joining techniques.

In some cases, the fused joint is configured to resist vapor ingress, environmental contamination, or fluid exposure. The joint can be formed to meet defined water vapor transmission thresholds or internal pressure ratings. In some implementations, the structure is rated to withstand burst pressures or extended humidity exposure while maintaining optical clarity and structural integrity.

In some cases, the integrated polymeric structure is used in applications that include an electronic display positioned within a sealed cavity. Some example applications can include fluid metering modules, outdoor sensor enclosures, portable instrumentation devices, or embedded systems operating in moisture-prone or submerged environments. The fused joint can support long-term deployment by reducing or eliminating the need for adhesives, gaskets, or glass-to-metal seals, while allowing consistent manufacturing using hot plate welding equipment.

Fewer, additional, or alternative blocks may be included in the routine 400 depending on the configuration of the structure to be formed. For example, in some cases, an internal cavity defined by the first component and the second component can be at least partially filled with a potting compound or encapsulant following formation of the fused joint. The potting material can include a silicone, polyurethane, or epoxy formulation and can be introduced to provide supplemental moisture sealing, mechanical stabilization, or vibration damping. In some cases, the integrated polymeric structure can be configured without potting to support optical clarity, serviceability, or airflow. Additional operations can include applying a surface coating, trimming flash from the weld bead, or attaching external mounting hardware or electronics.

Furthermore, in some cases, the second component includes a UV-protective coating or a surface-adhered optical film. In some cases, the second component includes an integrated UV absorbing layer formed as part of the bulk material. In other implementations, a discrete UV film or laminated protective sheet can be applied to an exterior-facing surface of the second component to reduce optical degradation and surface wear over time. The UV film can include a polycarbonate, acrylic, or fluoropolymer substrate configured for scratch resistance or ultraviolet light filtering.

### Terminology

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this invention may include, additional to its essential features described herein, one or more features as described herein from each other embodiment of the invention disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

1. An enclosure configured to limit vapor ingress, comprising:
an outer shell formed from high-density polyethylene (HDPE), the outer shell defining an opening;
a transparent window formed from cyclic olefin copolymer (COC), the transparent window positioned to cover the opening; and
a fused joint forming a continuous thermally bonded interface between the outer shell and the transparent window, the fused joint extending around the opening and characterized by a co-melted polymer interface with material continuity between the HDPE and COC components.

2. The enclosure of claim 1, wherein the fused joint is characterized by a co-melted region exhibiting material continuity between the HDPE of the outer shell and the COC of the transparent window at the continuous thermally bonded interface.

3. The enclosure of claim 1, wherein the fused joint is formed by hot plate welding to produce a continuous polymer-to-polymer bond without adhesives or mechanical fasteners.

4. The enclosure of claim 1, wherein the fused joint is configured to withstand an internal burst pressure of at least 150 psi.

5. The enclosure of claim 1, wherein the fused joint exhibits a tensile strength that is at least 80 percent of a tensile strength of the outer shell.

6. The enclosure of claim 1, wherein the enclosure exhibits a package-level water vapor transmission rate of less than 0.0003 grams per package per day.

7. The enclosure of claim 1, outer shell defines a stepped flange or an undercut ledge along the opening, and wherein the fused joint if formed along the stepped flange or undercut ledge.

8. The enclosure of claim 1, wherein the transparent window comprises a COC material having an optical transmittance of at least 50% in the visible light spectrum.

9. The enclosure of claim 1, wherein the transparent window includes a nominal thickness of at least 2 millimeters.

10. The enclosure of claim 1, wherein the transparent window is formed as a planar, lens-shaped, or contoured insert configured to optically align with internal electronics.

11. The enclosure of claim 1, wherein the outer shell includes high-density polyethylene (HDPE) selected from Black TOSAF HDPE KE900249, DOW® HDPE 8907 NT7, or a blend comprising between 85% and 95% HDPE and between 5% and 15% TOPAS® COC 8007S-04 by weight.

12. A welded assembly comprising:
a first portion formed from high-density polyethylene;
a second portion formed from cyclic olefin copolymer; and
a fused joint joining the first portion and the second portion, the fused joint comprising a continuous thermally bonded interface defined by a co-melted region exhibiting material continuity between the high-density polyethylene of the first portion and the cyclic olefin copolymer of the second portion.

13-20. (canceled)

21. The welded assembly of claim 12, wherein:
the first portion defines an opening;
the second portion forms an optically transmissive transparent window positioned to cover the opening; and
the fused joint extends continuously around a perimeter of the opening to form a moisture-limiting interface between the first portion and the transparent window.

22. The welded assembly of claim 21, wherein the fused joint forms a continuous polymer-to-polymer bond without adhesives or mechanical fasteners.

23. The welded assembly of claim 21, wherein the transparent window has an optical transmittance of at least 50 percent within a visible-light spectrum extending from 400 nanometers to 700 nanometers.

24. The welded assembly of claim 21, wherein the transparent window has a nominal thickness of at least 2 millimeters.

25. The enclosure of claim 11, wherein the outer shell comprises the blend, and wherein the blend comprises:

95. percent Black TOSAF HDPE KE900249 and 5 percent TOPAS® COC 8007S-04 by weight; or 90 percent Black TOSAF HDPE KE900249 and 10 percent TOPAS® COC 8007S-04 by weight.

26. The enclosure of claim 1, wherein the outer shell comprises Black TOSAF HDPE KE900249 and the transparent window comprises TOPAS® COC 8007S-04.

27. The enclosure of claim 1, wherein the transparent window exhibits a water vapor transmission rate of less than 0.03 grams per square meter per day.

28. The enclosure of claim 6, wherein the enclosure exhibits a package-level water vapor transmission rate of less than 0.0002 grams per package per day, and the enclosure is free of an internal desiccant, an internal coating, and a barrier liner.
